(19) United States
(12) Patent Application Publication
(10) Pub. No.: US 2007/0075127 A1
(43) Pub. Date: Apr. 5, 2007

(54) ORIENTATION-BASED POWER CONSERVATION FOR PORTABLE MEDIA DEVICES

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/561,981

(22) Filed: Nov. 21, 2006

Related U.S. Application Data
(60) Provisional application No. 60/752,730, filed on Dec. 21, 2005.

(51) Int. Cl. G06F 17/00

(52) U.S. Cl. 235/375

(57) ABSTRACT

A portable media player has an orientation-responsive power conservation feature. The portable media player includes a casing, processor, visual display, audio display, main memory functionally coupled to the processor, and a secondary memory functionally coupled to the processor. Media content is retrievably stored in the second memory. An orientation sensor transmits signals to the processor responsive to a spatial orientation of the casing with respect to gravity. A program has instructions executable by the processor to: (a) present media content to a user by displaying visual content on the visual display and playing audio content through the audio display; and (b) reduce power consumption of the visual display by lowering an intensity of display output when the orientation sensor indicates the spatial orientation of the casing is within certain boundaries, for example inverted with respect to gravity, while continuing to play audio content normally through the audio display.

### RELATED APPLICATION DATA

This application claims priority to provisional application Ser. No. 60/752,730, filed Dec. 21, 2005, the disclosure of which is hereby incorporated by reference herein in its entirety.

### FIELD OF THE APPLICATION

The present invention relates generally to a method, system, and apparatus for conserving power in a portable media player by detecting a user's orientation and adjusting the display of media in response to the detecting.

### BACKGROUND

Electronic Media Players have become popular personal entertainment devices due to their highly portable nature and interconnectivity with existing computer networks, such as the Internet. The accessibility and simplicity in downloading music files and other electronic media continues to fuel the popularity of these devices as is exemplified by Apple Computer, Inc.'s highly successful iPod (™) portable media player. Recent models also allow for the storage and display of personal photos allowing users to carry about a photo album stored in memory of the media player. Other models allow for the storage and display of music videos, movies, and other video content. Some manufacturers have competing Media Players offering various functionalities and file playing compatibilities in an effort to differentiate their products in the marketplace.

As discussed in Apple Computer, Inc.'s U.S. Patent Application Publication No. 2004/0224638 A1, to Fadell, et al., which is herein incorporated by reference in its entirety, an increasing number of consumer products are incorporating circuitry to play musical media files and other electronic media. Additional embodiments of media players are disclosed in the current applicant's co-pending U.S. Provisional Patent Application Ser. Nos. 60/648,197, filed on Jan. 27, 2005; 60/665,291 filed on Mar. 26, 2005; and 60/651,771, filed on Feb. 9, 2005; the aforementioned provisional applications are hereby incorporated by reference in their entirety. Apple Computer Inc.'s U.S. Patent Application Publication No. 2006/0017692, which is herein incorporated by reference in its entirety, discloses use of an accelerometer in a portable computing device. The accelerometer includes an orientation sensor.

Many portable electronic devices may include media player functionality and thus may be considered portable media players. For example, many portable electronic devices such as cellular telephones, portable gaming devices, and personal digital assistants (“PDAs”) include the ability to play electronic musical media in many of the most commonly available file formats including Moving Picture Experts Group-1 (“MPEG-1”) Audio Layer 3 (“MP3”), Audio Video Interleave (“AVI”), Waveform audio format (“WAV”), Moving Picture Experts Group (“MPG”), Quicktime (“QT”), Windows™ Media Audio (“WMA”), Audio Interchange File Format (“AIFF”), Audio (“AU”), Real Audio Media (“RAM”), Real Audio (“RA”), Movie files (“MOV”), Musical Instrument Digital Interface (“MIDI”), and so forth.

In the relevant art, portable media players enable users to listen to music as digital audio files and/or as part of digital video files through headphone or speakers. Portable media players also enable users to watch video files upon a screen. The screen is generally integrated into an easily viewable surface of the casing of the portable media player when the media player casing is held in certain ways with respect to the user. Thus there is a substantial difference between the audio output of the portable media player and the video output of the portable media player—the audio output is received by the user regardless of how the casing of the media player is positioned related to the user so long as the user is correctly wearing headphones or is within listening range of the speaker output. Video output, on the other hand, may be presented upon a screen of the media player, but if the user is not looking at the screen, it will not be received by the user. For example, if the media player is clipped to the user's belt, or within the user's pocket, or in the user's backpack, or otherwise held such that a clear line of sight does not exist between the screen of the portable media player and the eyes of the user, the user will not be receiving the video content. This is a common situation for users who often keep a media player in their pocket or in their backpack or on their belt for convenience during daily activities, receiving audio content through headphones that are not dependent upon the position of the casing. Thus if a user is playing, for example, a music video, listening to the audio content, but has the media player in his pocket and is therefore not watching the video, the video display content is wasted.

Of course, the concern is not the wasting of the video display content, but the wasting of the power used to drive the screen of the portable media player to display the video content when the user is only listening to the audio track of the media file. Because portable media players have a limited battery life, it is highly beneficial to conserve power wherever possible, eliminating wasted power usage. Thus, there is a substantial need for eliminating situations in which a user is playing a media file that includes video content but is only receiving the audio content because the casing of the portable media player is not positioned in a way that the user is viewing the screen (i.e., the portable media player is clipped to his or her belt, in his or her pocket, or in his or her backpack).

With respect to mobile devices with orientation sensing capabilities, some systems have been developed that perform limited functions in response to orientation, but the functions not address the unique needs of media players that display both audio and video content as described herein. For example, pending U.S. Patent Application Publication No. 2005/0212749, the disclosure of which is hereby incorporated by reference in its entirety, discloses a system in which a phone may turn itself off if it is placed face-down on a table. Such a system does not address the unique needs of a media player with dual visual and audio display modes and provides no means of conserving power by displaying an audio stream to the user while simultaneously dimming and/or turning off the video display based upon the orientation at which the device is held by a user. Similarly, such systems do not provide a seamless and natural user interface methodology for selecting between audio-only modes of display and combined audio-video modes of display. Thus there is a substantial need for an inventive solution to the problems described herein. More specifically there is a need for a portable media player device equipped with an intelligent power consumption system that is responsive to device orientation and automatically reduces power consumed by the video display if the device is held or placed at an physical orientation such that it is unlikely that the user is watching the video content of the media output even though he or she is still listening to the audio content.

### SUMMARY

A portable media player is provided that is equipped with both audio and video display capabilities can simultaneously present both the audio and video content of a media file to a user, such as a music video that includes both audio and video media content. Because a typical portable media player with video display capabilities generally includes the display screen in a handheld casing, the video content may not be easily viewed by the user when the casing is held in certain positions and/or orientations with respect to the user. For example, the main casing of the portable media player may be stored in a pocket of the user, clipped to the belt of a user, held in a backpack of the user, or otherwise positioned such that the user cannot easily view the video screen on the casing of the media player. Still, the user is likely to be listening to the audio content of the media file, such as the music track of a music video. Thus, in such a situation in which a user is listening to the audio track of a music video or other media file but is not looking at the screen, power is wasted to illuminate and/or drive the display screen hardware.

A portable media player has a limited battery life, and power consumption is therefore a concern. Thus, embodiments of the present invention are aimed at reducing this waste in power consumption by dimming and/or turning off the display screen on the casing of a portable media player (while keeping the audio stream playing) at moments in time when the casing that houses the display screen is held and/or positioned at an orientation that is unlikely to be used by the user for viewing.

Thus, embodiments of the present invention are directed to a method, apparatus, and computer program for conserving power consumed by the screen of a portable media player by automatically dimming and/or turning off the screen of a portable media player during certain periods while keeping the audio content playing to the user over those periods of time. In this way the user may continue to listen to the audio content, but power is saved by reducing power consumed on the screen of the portable media player. More specifically, embodiments of the present invention provide a system for automatically dimming and/or turning off the screen of a portable media player during periods of time in response to a detected orientation of the casing of the portable media player while keeping the audio content playing to the user over those periods of time, the detected orientation being such that it is unlikely that the user is viewing the screen of the portable media player because the orientation of the screen is not conducive to user viewing. In some preferred embodiments of the present invention an accelerometer sensor is used to detect the orientation of the portable media player with respect to the direction of gravity, automatically dimming and/or turning off the screen of a portable media player over periods of time while keeping the audio content playing to the user over those periods of time. The automatic dimming and/or turning off of the screen is performed in response to a detected orientation signal such that is unlikely that the user is viewing the screen of the portable media player even through the user is still listening to the audio content.

The media player of embodiments of the preset invention includes an accelerometer or other similar orientation sensing device in the casing for collecting data representative of the orientation of the media player casing with respect to the direction of gravity. The media player also includes software for processing the sensor data, determining whether the current orientation is conducive to user viewing or not, and turning off the screen and/or dimming the screen if the orientation is determined not to be conducive to user viewing.

Thus, the methods and apparatus of such embodiments of the present invention enable the software of the present invention, in combination with the sensor hardware, to determine whether and when the casing of the portable media player is oriented such that it is conducive to user viewing and if not, turns off the screen and/or dims the screen of the portable media player while keeping the audio content playing to the user. In this way a user may play a music video (or other audio-video content) and have the audio portion of the content play continuously over time but have the video portion of the content dimmed or turned off during periods of time when the media player casing (and thus the screen of the media player) is not in a viewing conducive orientation. In this way, power is conserved.

In a particular accelerometer embodiment, a single axis acceleration sensor is incorporated within the casing of the portable media player such that when the screen is oriented by the user in a vertical plane with respect to the gravitational reference frame, the sensing axis of the acceleration sensor is aligned with the direction of gravity. Thus, when the screen is held still in a vertical orientation, with the upper edge of the display area on top and the bottom edge of the display area on the bottom, the sensor reports an acceleration of approximately 1 g. This is because the sensing axis of the accelerometer is aligned with the direction of gravity and therefore reports an acceleration equal to 1 times the acceleration due to gravity. As plane of the display screen is tilted forward or backwards away from vertical by the user, the acceleration signal along the sensing axis drops towards zero g's, reaching zero when the plane of the display screen is positioned exactly horizontally with respect to the gravitational reference frame. When the plane of the display screen continues to tilt beyond this horizontal position, the sensing axis of the accelerometer is now inverted with respect to the direction of gravity, the sensor will begin reporting negative values. The negative values will increase to −1 g when the plane of the display screen returns to vertical, the upper edge of the display area now on the bottom and the bottom edge of the display area now on top. Thus when an accelerometer is affixed to the media player with an orientation as described above, the sensor will report values between 0 and 1 g for all orientations in which the screen is not inverted (i.e., the upper edge of the screen is at a higher elevation than the lower edge of the screen) and will report values between 0 and −1 g for all orientations in which the screen is invented (i.e., the upper edge of the screen is at an elevation below the lower edge of the screen).

It should be noted that the description above ignores the effect of accelerations induced upon the media player due to motion, such as the user shaking or moving the media player. These acceleration effects will be transients. The acceleration effects discussed above will only vary with tilting of the media player and will remain constant as the media player is held at a particular orientation. Filtering methods and time averaging methods on the sensor signal may be used to eliminate and/or reduce the transients described above. Moreover, the above description assumes the media player is used on Earth, with 1 g being the acceleration caused by the mass of the planet.

In one such embodiment, the software of embodiments of the present invention is configured to turn off the display screen and/or dim the display screen when the acceleration signal reported by the acceleration sensor reports an acceleration value that drops below a certain threshold. More specifically, these software embodiments may be configured to turn off the display screen and/or dim the display screen when the acceleration signal reported by the acceleration sensor configured as aforementioned reports an acceleration value that drops below −0.1 g. Such an acceleration corresponds to the range of orientations such that the sensing axis of the accelerometer reports a component pointing in the inverse direction to gravity that exceeds 10% of the strength of gravity. In this way, in any orientation where the upper edge of the display screen is at an elevation that is lower than the bottom edge of the display screen by more than a threshold amount, the display screen is turned off or dimmed. This makes sense for the user, for the user is highly unlikely to be viewing the displays screen in such inverted orientations.

In some such embodiments of the present invention, the software is configured to turn off the display screen and/or dim the display screen when the acceleration signal reported by the acceleration sensor configured as aforementioned reports an acceleration value that drops below a certain threshold acceleration for more than a certain threshold amount of time. For example, the software may be configured to turn off the display screen and/or dim the display screen when the acceleration signal reported by the acceleration sensor configured as aforementioned reports an acceleration value that drops below −0.1 g. for more than 5 seconds.

In some such embodiments, the software is configured to turn on the display screen and/or restore the display screen to a nominal viewing brightness when the acceleration signal reported by the acceleration sensor configured as aforementioned reports an acceleration value that rises above a certain threshold acceleration for more than a certain threshold amount of time. For example, the software may be configured to turn off the display screen and/or dim the display screen when the acceleration signal reported by the acceleration sensor configured as aforementioned reports an acceleration value that rises above −0.1 g. for more than 1.5 seconds.

In many such embodiments the threshold time used to turn off the screen is longer than the threshold time to turn on the screen (as in the examples above). This is because the user often desires the screen to come on quickly when he or she brings it into a convenient viewing orientation but does not need the screen to turn off quickly when the user moves the screen into an orientation that is not conducive to viewing.

In some embodiments, the headphone cable that plugs into the main casing of the media player is oriented such that it plugs into the bottom of the casing with respect to the orientation of the screen. Thus, it is a convenient location for a user to have headphones plugged in and simultaneously keep the media player in a pocket or on a belt such that the screen is upside own when the cable is pointed up. Such an orientation will trigger the software as described in the paragraphs above to turn off (or dim) the screen of the portable media player while keeping the audio content playing. In this way a user can put the media player in his pocket and/or on his belt and thereby have power conserved by reducing the power consumed by the video content of the media file. By having the audio plug on the underside (with respect to the normal viewing orientation of the screen), the media player may reside upside down in the users pocket or belt and allow for convenient routing of the headphone wires.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a generalized block diagram of a portable media player according to at least one embodiment of the invention;

FIG. 2 illustrates a portable media player equipped with an accelerometer internal to the casing according to at least one embodiment of the invention;

FIGS. 3A and 3B illustrate orientations of the media player and how an orientation sensor coupled to the media player casing can provide data by which such non-conducive orientations may be identified by software according to at least one embodiment of the invention; and

FIG. 4 illustrates a flow chart for an example power conservation method according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Over recent years, portable media devices have come to include a plurality of output technologies for presenting media content to users, the output technologies including both a visual display and an audio display. The visual display generally includes a screen such as an LCD or plasma screen. The audio display generally includes a sound amplifier and headphones and/or speakers. In general, both audio and visual displays are operative concurrently, presenting information to users through visual and audio modes simultaneously. This is often necessary and valuable; however, there are substantial amounts of time during the usage of a portable media player that power is wasted on the visual display. This is because there is substantial time during the usage of a portable media player that a typical user will listen to the audio content but not look at the video content. Even for a portable media player that is playing a music video which includes both audio and visual content, there may be substantial amounts of time that a user is only listening to the audio content and ignoring the video content. As a result power is wasted upon the visual display. This is problematic because the battery life of a portable media player is limited and the video display consumes a consequential portion of the total power consumed by the device.

Thus, to conserve power and increase the battery life of portable media devices, embodiments of the present invention provide an automatic means of dimming and/or turning off the visual display at moments in time when a user is unlikely to be viewing the video content. More specifically, embodiments of the present invention provide an orientation sensor within the portable media device, where the orientation sensor determines whether the portable media device is being held by the user in a manner conducive to viewing and if not being held at such an orientation, dims and/or turns off the display and thereby conserves power. Thus, a user may use the portable media device in a natural manner, holding and carrying the device for convenient usage, the device automatically regulating power to the display based upon how the device is carried and/or held based upon an integrated orientation sensor. The device also includes an over-ride interface by which a user may deliberately turn on or turn off the visual display while leaving the audio display active. In this way the user may bypass the automatic power consumption regulation methods and apparatus provided by the current invention.

A portable media player is equipped with both audio and video display capabilities such that it can simultaneously present both the audio and video content of a media file to a user. For example, a music video media file that includes both audio and video media content may be displayed to the user through such a portable media player. The audio content is presented/displayed through headphones or speakers, and the video media content is displayed through a screen mounted within or upon the casing of the portable media player. Because a typical portable media player with video display capabilities generally includes the display screen in a handheld casing, the video content may not be easily viewed by the user when the casing is held in certain positions and/or orientations with respect to the user. For example, the casing of the portable media player may be stored in a pocket of the user, clipped to the belt of a user, held in a backpack of the user, or otherwise positioned such that the user cannot easily view the video screen on the casing of the media player. Still, the user is likely to be listening to the audio content of the media file, for example the music track of a music video. Thus, in such a situation in which a user is listening to the audio track of a music video or other media file but is not looking at the screen, power is wasted to illuminate and/or drive the display screen hardware. Because a portable media player has limited battery life, power consumption is a concern. Thus, embodiments of the present invention are aimed at reducing this waste in power consumption by dimming and/or turning off the display screen on the casing of a portable media player (while keeping the audio stream playing) at moments in time when the casing that houses the display screen is held and/or positioned at an orientation that is unlikely to be used by the user for viewing. Thus, the audio stream continues to play normally to the user when the video display is automatically dimmed or turned off by the orientation-based power conservation feature. This allows the audio content to continue to play to the user at a substantially unchanged power level while power is reduced to the video display. The user therefore experiences audio content that is substantially perceptually unchanged (i.e., it continues to play normally), while the video content is automatically dimmed or turned off.

Embodiments of the present invention provide a method, apparatus, and computer program for conserving power consumed by the screen of a portable media player by automatically dimming and/or turning off the screen of a portable media player during certain periods while keeping the audio content playing normally to the user over those periods of time. In this way the user may continue to listen to the audio content, but power is saved by reducing power consumed on the screen of the portable media player. More specifically, embodiments of the present invention provide a system for automatically dimming and/or turning off the screen of a portable media player during periods of time in response to a detected orientation of the casing of the portable media player while keeping the audio content playing to the user over those periods of time. The detected orientation is such that it is unlikely that the user is viewing the screen of the portable media player because the orientation of the screen is not conducive to user viewing. In general, such functions are controlled by control software running upon a processor of the portable media player. Where necessary, computer programs, algorithms and routines are envisioned to be programmed in a high level language object oriented language, for example Java™, C++, C#, or Visual Basic™.

Embodiments of the present invention are relevant to any portable electronic device that either is a dedicated media player or provides media player functionality by accessing digital audio and/or video files from a local memory store and plays the files for users to experience.

Embodiments of the present invention provide a system for conserving power sent to the screen of a portable media player by automatically dimming and/or turning off the screen of the portable media player over a period of time while keeping the audio content playing to the user over that period of time. In this way the user may continue to listen to the audio content, but power is saved by reducing power consumption on the screen of the portable media player. More specifically, embodiments of the present invention provide a system for automatically dimming and/or turning off the screen of a portable media player over a period of time in response to a detected orientation of the casing of the portable media player while keeping the audio content playing to the user over that period of time, where the detected orientation is such that it is unlikely that the user is viewing the screen of the portable media player. In some preferred embodiments of the present invention an accelerometer sensor is used to detect the orientation of the portable media player with respect to the direction of gravity, automatically dimming and/or turning off the screen of a portable media player over a period of time while keeping the audio content playing to the user over that period of time, the automatic dimming and/or turning off of the screen being performed in response to a detected orientation signal such that is unlikely that the user is viewing the screen of the portable media player even through the user is listening to the audio content.

In some preferred embodiments of the present invention an accelerometer sensor is used to detect the orientation of the portable media player with respect to the direction of gravity, and automatically dim and/or turn off the screen of a portable media player over periods of time while keeping the audio content playing to the user over those periods of time. The automatic dimming and/or turning off of the screen is performed in response to a detected orientation signal such that is unlikely that the user is viewing the screen of the portable media player even through the user is still listening to the audio content. The media player according to the preset invention therefore includes an accelerometer or other similar orientation sensing device in the casing for collecting data representative of the orientation of the media player casing with respect to the direction of gravity, the screen of the media player mounted within the casing. Thus, the accelerometer according to the present invention is configured to sense the orientation of the screen of the portable media player with respect to the direction of gravity. The media player also includes software for processing the sensor data, determining whether the current orientation is conducive to user viewing or not, and turning off the screen and/or dimming the screen if the orientation is determined not to be conducive to user viewing.

Thus, the methods and apparatus of such embodiments of the present invention enable the software of the present invention, in combination with the sensor hardware, to determine whether and when the screen of the portable media player is oriented such that it is conducive to user viewing and if not, turns off the screen and/or dims the screen of the portable media player while keeping the audio content playing to the user. In this way, a user may play a music video (or other audio-video content) and have the audio portion of the content play continuously over time but have the video portion of the content dimmed or turned off during periods of time when the screen is not in a viewing conducive orientation. In this way, power is conserved.

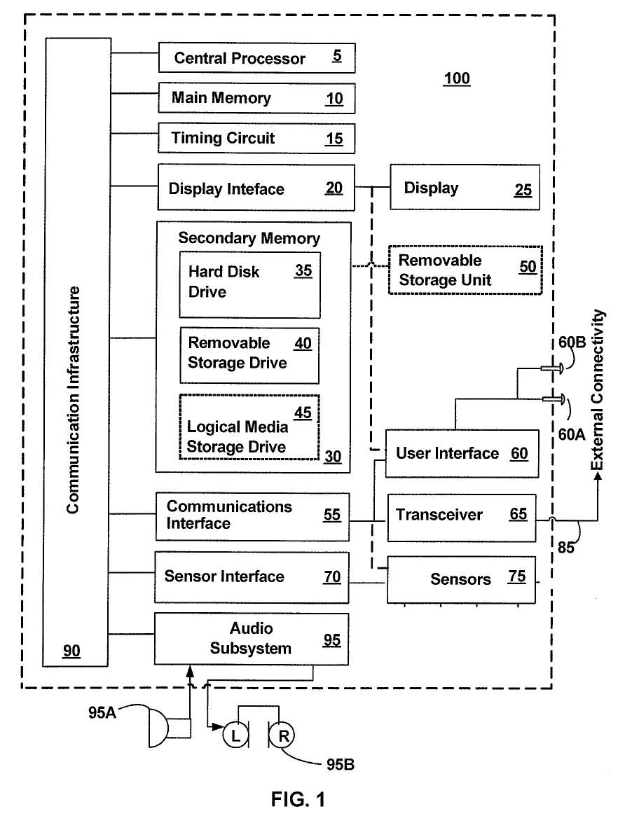

FIG. 1 illustrates a generalized block diagram of a portable media player 100 according to at least one embodiment of the invention. The portable media player 100 includes a communications infrastructure 90 used to transfer data, memory addresses where data items are to be found and control signals among the various components and subsystems associated with the portable media player 100. A central processor 5 is provided to interpret and execute logical instructions stored in the main memory 10. The main memory 10 is the primary general purpose storage area for instructions and data to be processed by the central processor 5. The main memory 10 is used in its broadest sense and includes RAM, EEPROM and a ROM. A timing circuit 15 is provided to coordinate activities within the portable media player in near real time and to make time-based assessments of sensor data collected by sensors on board (or interfaced to) the portable media player. The central processor 5, main memory 10 and timing circuit 15 are directly coupled to the communications infrastructure 90.

A display interface 20 is provided to drive a display 25 associated with the portable media player 100. The display interface 20 is electrically coupled to the communications infrastructure 90 and provides signals to the display 25 for visually outputting both graphics and alphanumeric characters. The display interface, may for example, display music videos, movies, and personal photographs accessible from a memory of the portable media player. The display interface may also, for example, display textual play lists of songs or other media items upon the portable media player. The display interface may also, for example, display user interface controls and/or menus for interacting with the software of the portable media player. The display interface may also, for example, provide a menu of available simulated instruments from which a user may select through graphical user interface options. The display interface is attached to the casing of the portable media player. The display interface 20 may include a dedicated graphics processor and memory to support the displaying of graphics intensive media. The display 25 may be of any type (e.g., cathode ray tube, gas plasma) but in most circumstances will usually be a solid state device such as liquid crystal display.

A secondary memory subsystem 30 is provided which houses retrievable storage units such as a hard disk drive 35, a removable storage drive 40, an optional logical media storage drive 45 and an optional removal storage unit 50. One skilled in the art will appreciate that the hard drive 35 may be replaced with flash memory. The secondary memory may be used to store a plurality of media files, including but not limited to a plurality of digital songs, a plurality of digital images, a plurality of personal photographs, a plurality of music videos, a plurality of other videos.

The removable storage drive 40 may be a replaceable hard drive, optical media storage drive or a solid state flash RAM device. The logical media storage drive 45 may include a flash RAM device, an EEPROM encoded with playable media, or optical storage media (CD, DVD). The removable storage unit 50 may be logical, optical or of an electromechanical (hard disk) design.

A communications interface 55 subsystem is provided which allows for standardized electrical connection of peripheral devices to the communications infrastructure 90 including serial, parallel, USB, and Firewire™ connectivity. For example, a user interface 60 and a transceiver 65 are electrically coupled to the communications infrastructure 90 via the communications interface 55. As discussed herein, the term “user interface” 60 includes the hardware and operating software by which a user interacts with the portable media player 100 and the means by which the portable media player conveys information to the user and may include the display 25.

The transceiver 65 facilitates the remote exchange of data and synchronizing signals between the portable media player 100 and other devices in processing communications 85 with the portable media player 100. The transceiver 65 is envisioned to be of a radio frequency type normally associated with computer networks for example, wireless computer networks based on BlueTooth™ or the various Institute of Electrical and Electronics Engineers (“IEEE”) standards 802.11x, where x denotes the various present and evolving wireless computing standards, for example Worldwide Interoperability for Microwave Access (“WiMax”) 802.16 and Wireless Regional Area Networks (“WRAN”) 802.22. Alternately, digital cellular communications formats compatible with for example Global System for Mobile Communications (“GSM”), 3G and evolving cellular communications standards. Both peer-to-peer (“PPP”) and client-server models are envisioned for implementation of the invention. In a third alternative embodiment, the transceiver 65 may include hybrids of computer communications standards, cellular standards and evolving satellite radio standards.

The user interface 60 employed on the portable media play 100 may include a pointing device (not shown) such as a mouse, thumbwheel or track ball, an optional touch screen (not shown); one or more push-button switches 60A, 60B; one or more sliding or circular rheostat controls (not shown) and one or more switches (not shown.) The user interface 60 provides interrupt signals to the processor 5 that may be used to interpret user interactions with the portable media player 100 and may be used in conjunction with the display 25.

The portable media player also includes a specialized orientation sensor that detects the orientation of a casing portion of the portable media player. More specifically, the orientation sensor detects the orientation of the screen of the portable media player by detecting the orientation of a portion of the casing that is physically fixed in orientation with respect to the screen. The specialized orientation sensor may include a tilt sensor of various configurations. In some embodiments, the orientation sensor is an accelerometer that detects orientation based upon the acceleration due to gravity imposed by the mass of the earth. In this way the accelerometer can determine an orientation relative to the direction of gravity based upon the magnitude of the detected acceleration (assuming no other accelerations are acting upon the sensor). For example, if the value detected by the accelerometer is 1 g, the sensing axis of the accelerometer is pointing straight down along the direction of gravity. If the accelerometer reads 0 g, the sensing axis of the accelerometer must be pointed horizontal (i.e., orthogonal to the direction of gravity). If the accelerometer reads −1 g, the sensing axis of the accelerometer is pointing straight up, the inverse of the direction of gravity. If the accelerometer reads a value between 0 and 1 g, the sensing axis of the accelerometer is pointing downward with at least some vector component. If the accelerometer reads a value between 0 and −1 g, the sensing axis of the accelerometer is pointing upward with at least some vector component. In this way the directionality of the screen of the portable media player may be determined based upon the sensor values read from an accelerometer that has a fixed sensing orientation with respect to the screen. This will be described below.

Thus the portable media player includes one or more sensors 75 for detecting an orientation of the screen of the portable computing device with respect to gravity. The sensors are supported by a sensor interface 70 that allows one or more sensors 75 to be operatively coupled to the communications infrastructure 90. The sensor interface 70 may monitor interactions with the user interface 60. For example, the sensor interface 70 may be used to monitor a user's interaction with the one or more push-button switches 60A, 60B. An interrupt circuit may be incorporated into the hardware supporting the communications infrastructure 90.

The sensors 75 are generally installed within the case (not shown) housing the portable media player 100 such that the sensing orientation of the sensor is fixed with respect to the screen of the portable media player. The most common sensor to be used to detect orientation is an accelerometer. In some embodiments, a single axis accelerometer is employed, the axis of detection of the accelerometer being oriented along the lengthwise axis of the portable media player. In other embodiments, multi axis accelerometers may be used.

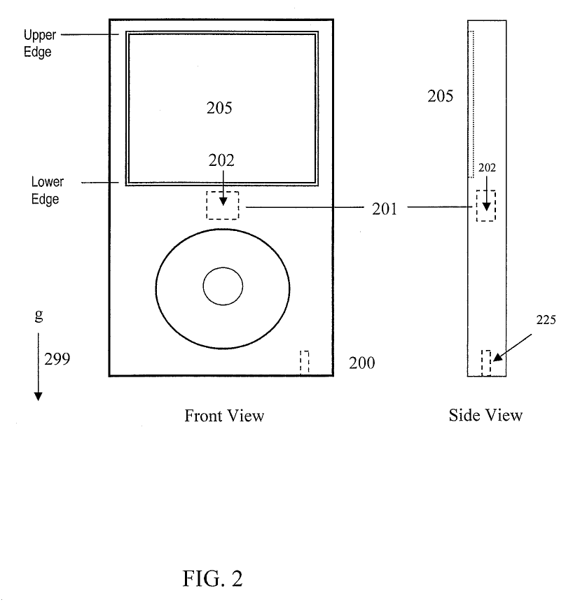

FIG. 2 illustrates a portable media player 200 equipped with an accelerometer 201 internal to the casing according to at least one embodiment of the invention. The portable media player 200 is shown from a front view and a side view. The accelerometer is indicated by the dotted rectangle 201. The sensing axis of the accelerometer 201 is orientated to detect accelerations imparted by the user along the lengthwise axis of the media player in the direction indicated by arrow 202 in FIG. 2. The accelerometer 201 is coupled to the casing of the media player 200 such that the orientation of the sensing axis is fixed with respect to the screen 205 of the media player 200. More specifically, the sensing axis of the accelerometer 201 is oriented such that it aligns with the direction of gravity 299 when the screen 205 of the portable media player 200 is oriented in a vertical plane with respect to gravity as shown. More specifically, the sensing axis of the accelerometer 201 is oriented such that it aligns with the direction of gravity 299 when the screen of the portable media player 200 is oriented in a vertical plane with respect to gravity, such that the upper edge of the of the display area is positioned at a higher elevation than the lower edge of the display area. In other words, the screen is positioned as shown in FIG. 2 with the screen display area right-side up with respect to the gravity, such that the upper edge is above the lower edge. The data from the sensor is processed by software running upon the media player to determine whether the screen of the media player 200 is in an orientation that is conducive to user viewing. If so, the screen operates normally. If not, the screen may be automatically turned off, or dimmed, while the audio continues to play in a substantially unchanged manner.

Also shown in FIG. 2 is an audio jack 225 for plugging in headphones. As shown, the audio jack 225 is provided on the underside of the media player casing such that headphones get plugged in from below when the media player 200 is oriented with the right-side up screen as shown in the figure. This particular arrangement is beneficial for embodiments of the present invention because it allows a user to put the media player 200 in his or her pocket with the screen oriented downward (i.e., the lower edge being at a higher elevation than the upper edge) and maintain easy access to the audio jack. This allows convenient wire routing when the screen is oriented upside down in a pocket or on a belt.

Referring back to FIG. 1, an audio subsystem 85 is provided and electrically coupled to the communications infrastructure 90. The audio subsystem 85 provides for the playback and recording of digital media, for example, multi or multimedia encoded in any format, such as, for example, Moving Picture Experts Group-1 (“MPEG-1”) Audio Layer 3 (“MP3”), Audio Video Interleave (“AVI”), Waveform audio format (“WAV”), Moving Picture Experts Group (“MPG”), QuickTime (“QT”), Windows™ Media Audio (“WMA”), Audio Interchange File Format (“AIFF”), Audio (“AU”), Real Audio Media (“RAM”), Real Audio (“RA”), Movie files (“MOV”), Musical Instrument Digital Interface (“MIDI”), and so forth. The audio subsystem 85 includes a microphone input port 95A for input of voice commands and a headphone, headset, ear buds or speaker output 95B. Connection of the microphone 95A and/or headphones 95B includes both traditional cable and wireless arrangements such as BlueTooth™ are known in the relevant art. As referred to in this specification, “media” refers to video, audio, streaming and any combination thereof.

In addition, the audio subsystem 85 is envisioned to optionally include features such as graphic equalization, volume, balance, fading, base and treble controls, surround sound emulation, and noise reduction. One skilled in the art will appreciate that the above cited list of file formats is not intended to be all-inclusive.

The portable media player 100 includes an operating system, the necessary hardware and software drivers necessary to fully utilize the devices coupled to the communications infrastructure 90, media playback and recording applications, and at least one control program 240 operatively loaded into the main memory 10. The control program may perform multiple functions, such as the automatic selection of media items from a plurality of media items stored in memory. The control program may also, for example, perform the automatic population of play lists and/or the automatic re-ordering of play lists. The control program also processes play lists, playing songs and/or displaying images in accordance with the sequential requirements of one or more play lists stored in memory. In some embodiments the play lists are downloaded from external sources. The control program manages such downloading processes. The control program also manages the downloading of new media items into the memory of the portable media player.

The control program is further operative to perform other functions. For example, the control program is operative to monitor the orientation of the media player (i.e., the orientation of the screen of the media player) by reading the associated sensor 75 and storing data from said sensor in memory over time. The control program may also read data from timing circuit 15. The control program may further filter and/or time-average the sensor data. The control program processes the sensor data from sensor 75 (which is often an accelerometer) and determines based upon the time varying characteristics of the sensor data whether or not to turn off (or dim) the display screen in response to a detected orientation of the screen that is not conducive to user viewing.

References to the at least one control program 240 may be made in both singular and plural form. No limitation is intended by such grammatical usage as one skilled in the art will appreciate that multiple programs, objects, subprograms routines, algorithms, applets, contexts, etc. may be implemented programmatically to implement the various embodiments of the invention.

The control program may also perform predictive functions, automatically selecting media items for the user that are statistically likely for the user to be in the mood for at a given time. A detailed discussions of the at least one control program 240 that performs predictive functions are provided in U.S. Provisional Patent Application Ser. No. 60/651,771, filed on Feb. 9, 2005, and U.S. patent application No. 11/267,079, filed on Nov. 3, 2005 to the instant inventor, both of which are herein incorporated by reference in their entirety. Optionally, the portable media player 100 is envisioned to include at least one remote authentication application, one or more cryptography applications capable of performing symmetric and asymmetric cryptographic functions, and secure messaging software (not shown.)

It should be noted that in some embodiments of the present invention, the user may selectively override the automatic screen dimming (or shut off) features if he or she wants to view the screen in an orientation that is not normally conducive to viewing.

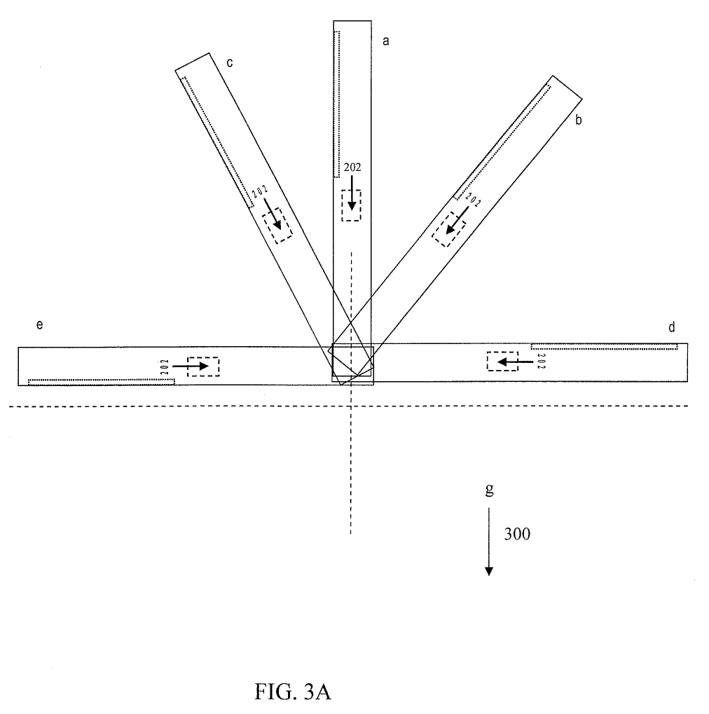

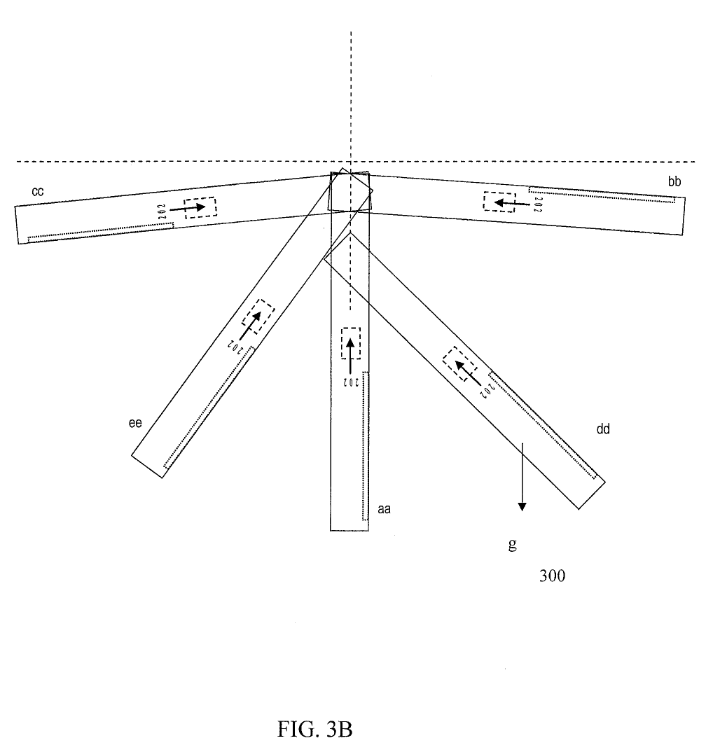

FIGS. 3A and 3B illustrate further described orientations of the present invention that are not conducive to user viewing and to further illustrate how orientation sensor coupled to the media player casing (directly or through an intervening member) can provide data by which such non-conducive orientations may be identified by software according to at least one embodiment of the invention. As shown in FIG. 3A, a media player according to the present invention is shown in five different orientations (a, b, c, d, and e).

The orientation of the media player labeled as (a) corresponds with the side view of the media player shown in FIG. 2 such that the plane of the screen of the media player is vertical with respect to the direction of gravity 300. As also discussed with respect to FIG. 2, the direction of sensing axis 202 shown for media player orientation (a) is such that it is aligned with the direction of gravity 300. In such a configuration the sensor reads the full strength of gravity (assuming the media player is at rest). Thus for orientation (a) the sensor (which is assumed to be an accelerometer in this embodiment) reads the full acceleration value of 1 g.

The orientation of the media player labeled as (e) corresponds with the media player being tilted forward from vertical by an angle of 90 degrees as shown in the figure. In this orientation the plane of the screen of the media player is horizontal with respect to the direction of gravity 300. In this orientation the direction of sensing axis 202 is oriented orthogonal to the direction of gravity 300 and thus does not read any acceleration of gravity. Thus, for orientation (e), the sensor (which is assumed to be an accelerometer in this embodiment) reads 0 g. Of course, signal noise and slight angular variations may make the value be not exactly 0, but it will approach 0 g at this orientation.

The orientation of the media player labeled as (d) corresponds with the media player being tilted backward from vertical by an angle of 90 degrees as shown in the figure. In this orientation the plane of the screen of the media player is also horizontal with respect to the direction of gravity 300. In this orientation the direction of sensing axis 202 is also oriented orthogonal to the direction of gravity 300 and thus does not read any acceleration of gravity. Thus for orientation (d), the sensor (which is assumed to be an accelerometer in this embodiment) reads 0 g. Of course, signal noise and slight angular variations may make the value be not exactly 0, but it will approach 0 g at this orientation.

The orientations of the media player labeled as (c) and (b) correspond with the media player being tilted an intermediate amount forward from vertical and backwards from vertical respectively. The direction of sensing axis 202 has a vector component in the gravity 300 and a vector component that is orthogonal to the direction of gravity. Thus for both of these orientations and any similar orientations the sensor will report a value that is greater than 0 g and less than 1 g. In fact, for any orientation between orientation (e) and orientation (a), the sensor will report a value between 0 g and 1 g, the closer the orientation is to (a) the closer the sensor value will be to 1 g. Similarly, for any orientation between orientation (a) and orientation (d), the sensor will report a value between 0 g and 1 g, the closer the orientation is to (a) the closer the sensor value will be to 1 g. Again, the above description assumes the media player is at rest and is not being jostled and jolted and imparted with other transient acceleration values. And as mentioned previously, such transients may be filtered and/or time averaged such that they can be removed and/or reduced from the data.

Thus for sensor readings that report a value between 0 g and 1 g, the orientation of the media player must be in the range of orientations from (e) to (a) or from (a) to (d). This fact will be used by the software of the present invention to determine whether a media player screen is in an orientation that is conducive to user viewing. This is because all such orientations in this range may be considered by the software of embodiments of the present invention to be conducive to user viewing in various user postures and configurations. For example, orientations at or near configuration (a) are highly conducive to user viewing when a user is in a normal upright posture. A user who is standing and holding the media player for viewing will generally hold it at or near a configuration such as (a) or may tilt it back slightly at a configuration between (a) and (b). A user sitting a desk will often tilt back the media player more, holding it somewhere between configuration (b) and (d). In fact, some users will lay the media player flat on the desk and view it at or near configuration (d). A user who is reclined far back in a chair will often tilt a media player forward for convenient viewing, using an orientation between (a) and (c). A user who is lying down in bed will tilt it even more forward, approaching orientation (e). In fact, a user lying in bed may hold the media player directly above him, held flat in an orientation at or near (e). Thus, the full range of orientation from (d) to (a) to (e) are conducive to user viewing in typical user postures from standing and sitting to reclining and laying in bed. Thus the software of the present invention may be configured to determine that the screen of the media player is positioned at an orientation conducive to user viewing if the acceleration sensor reports a value between 0 g and 1 g, where g represents the acceleration due to gravity. Anything less than 0 g means that the media player has tilted so far forward that it has passed orientation (e) and is now being inverted or that the media player has been tilted so far forward that it has passed orientation (d) and is also being inverted. By inverted it is meant that the upper edge of the screen is placed at an absolute elevation than the lower edge of the screen. A number of inverted orientations for the media player are shown with respect to FIG. 3B.

As shown in FIG. 3B, if a user tilts a media player back so far that the angle exceeds the horizontal, it will begin to be inverted. Such an orientation is at (bb) and is not conducive to user viewing in any common posture a person might assume. At such an orientation the sensing axis 202 of the accelerometer will report a slight negative value for acceleration because a component of the sensing axis is oriented in the direction opposite to gravity. Thus such an orientation can be identified by an acceleration reading of less than 0 g. For example, the acceleration read for orientation (bb) might be −0.1 g.

Similarly, if the user tilts the media player forward so far that the angle exceeds horizontal, it will also begin to be inverted. Such an orientation is at (cc) and is not conducive to user viewing in any common posture a person might assume. At such an orientation the sensing axis (202) of the accelerometer will report a slight negative value for acceleration because a component of the sensing axis is oriented in the direction opposite to gravity. Thus, such an orientation can be identified by an acceleration reading of less than 0 g. For example, the acceleration read for orientation (cc) might be −0.1 g If the user tilts media player even for forward than at (cc) or even more backwards than at (bb), other inverted orientations such as (dd), (ee) and (aa) will be achieved. Such orientations are not conducive to user viewing in any common posture a person might assume. In such orientations, the sensing axis 202 of the accelerometer will report a negative value for acceleration because a component of the sensing axis is oriented in the direction opposite to gravity. Thus, such an orientation can be identified by an acceleration reading of less than 0 g. For example, the acceleration read for orientation (aa) where the sensor points straight up would be −1 g. The software of the present invention may therefore be configured to determine that the screen of the media player is positioned at an orientation that is not conducive to user viewing if the acceleration sensor reports a value between −0.1 g and −1 g, where g represents the acceleration due to gravity. At such orientations, the software according to the present invention may be configured to turn off the screen (or dim the screen) to conserve power while still playing the audio stream to the user. This is because a user is not likely to be viewing the visual content of the media files at such non conducive orientations.

In one such embodiment, the software according to the present invention is configured to turn off the display screen and/or dim the display screen when the acceleration signal reported by the acceleration sensor reports an acceleration value that drops below a certain threshold. More specifically, this software embodiment of the present invention may be configured to turn off the display screen and/or dim the display screen when the acceleration signal reported by the acceleration sensor configured as discussed above reports an acceleration value that drops below −0.1 g. Such an acceleration corresponds to the range of orientations such that the sensing axis of the accelerometer reports a component pointing in the inverse direction to gravity that exceeds 10% of the strength of gravity. In this way, any orientation such that the upper edge of the display screen is at an elevation that is lower than the bottom edge of the display screen by more than a threshold amount, the display screen is turned off or dimmed. This makes sense for the user, for the user is highly unlikely to be viewing the display screen in such inverted orientations.

In some such embodiments of the present invention, the software is configured to turn off the display screen and/or dim the display screen when the acceleration signal reported by the acceleration sensor configured as aforementioned reports an acceleration value that drops below a certain threshold acceleration for more than a certain threshold amount of time. For example, the software of the present invention may be configured to turn off the display screen and/or dim the display screen when the acceleration signal reported by the acceleration sensor configured as aforementioned reports an acceleration value that drops below −0.1 g. for more than 5 seconds.

In some such embodiments of the present invention, the software is configured to turn on the display screen and/or restore the display screen to a nominal viewing brightness when the acceleration signal reported by the acceleration sensor configured as aforementioned reports an acceleration value that rises above a certain threshold acceleration for more than a certain threshold amount of time. For example, the software of the present invention may be configured to turn off the display screen and/or dim the display screen when the acceleration signal reported by the acceleration sensor configured as aforementioned reports an acceleration value that rises above −0.1 g. for more than 1.5 seconds.

In many such embodiments, the threshold time used to turn off the screen is longer than the threshold time to turn on the screen (as in the examples above). This is because the user often desires the screen to come on quickly when he or she brings it into a convenient viewing orientation but does not need the screen to turn off quickly when the user moves the screen into an orientation that is not conducive to viewing.

It should be noted that in some media player embodiments the orientation of the imagery displayed upon the display screen may be electronically adjustable. In such embodiments, the definition of which edge of the display screen is the upper edge and which edge is the lower edge may be determined relative to the orientation of the imagery on the display screen such that the upper edge is nearest to the top of the displayed imagery and the lower edge is nearest to the bottom of the displayed imagery. In many common embodiments the orientation of the displayed imagery is fixed with respect to the display screen such that the top of the imagery is generally nearest to an understood upper edge of the display screen and the bottom of the imagery is generally nearest to an understood lower edge of the display screen.

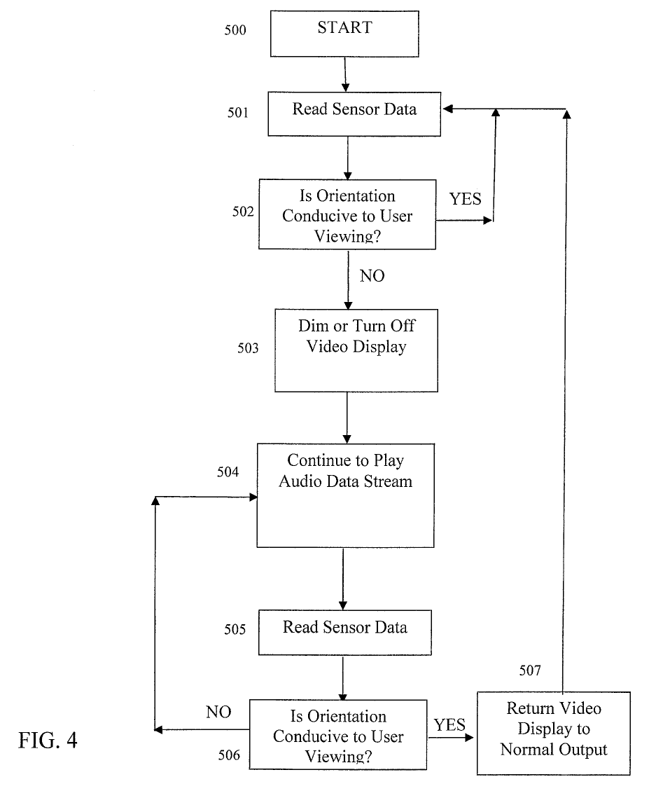

FIG. 4 illustrates a flow chart for an example power conservation method according to at least one embodiment of the invention. The process begins at step 500 where it is assumed that an audio-video media file is currently being accessed and played, and the media player is conveying both audio and video content to the user. The accessing of the media file from memory and the playing of the content through audio and video displays may be performed by a background process that runs in parallel with the power conservation program shown in the figure. The background process is affected by the power conservation process at certain steps.

Once started, the power conservation program proceeds to step 501 where the processor of the media player reads one or more orientation sensors on board the media player. As described above the sensors may include an accelerometer that provides acceleration data. Reading sensor data may include filtering, time averaging, and/or storing and accessing data over a period of time. In step 502, the sensor data is processed to determine whether the screen of the media player is in an orientation that is likely to be conducive to user viewing. If yes, the software jumps back to 501, repeating the reading of sensor data while the media file continues to play normally, and the video and audio content is displayed to the user. If no, the software jumps to 503 where the video display is turned off (or dimmed) to conserve power. The process then proceeds to 504 where the audio content of the media file continues to play normally to the user (i.e., at a substantially unchanged power level). It should be noted that the determination that the media player is not in an orientation that is conducive to viewing may include a time component as well as an orientation component. For example, the determination may require that the media player is in an orientation not conducive to viewing for more than a threshold amount of time (for example 5 seconds), as described previously.

If the software triggers a power conservation mode, turning off (or dimming) the video display at 503 and continuing to play the audio content in the background to the user, the process next proceeds to 505 as shown in the figure. At step 505 the sensor data is read again. Reading sensor data may include filtering, time averaging, and/or storing and accessing data over a period of time. The process then proceeds to step 506 where the sensor data is processed to determine whether the orientation is conducive to user viewing. If not, the process loops back to 504 wherein the audio stream continues to play to the user and the screen remains off or dimmed (as it was prior to this step). Thus, for as long as the screen remains at an orientation that is not conducive to viewing, the screen remains off (or dimmed) and the audio content continues to play normally. If, on the other hand, the process at 506 determines that the screen has returned to an orientation that is conducive to viewing, the process proceeds to step 507 wherein the video display is returned to a normal output configuration. The process then returns to step 501 and the whole process repeats. The process of determining at 506 whether the screen has returned to an orientation that is conducive to viewing may include both an orientation component and a time component. For example, the determination may require that the media player is in an orientation conducive to viewing for more than a threshold amount of time (for example, 1.5 seconds), as described above.

Thus, the software process described herein may be configured to require that the media player screen be held in an non-conducive viewing orientation for more than 5 seconds for the screen to be turned off (or dimmed) and then may require that the media player screen be held in a conducive viewing orientation for more than 1.5 seconds for the screen to be returned to a normal display configuration. In this way the screen is not turned on and/off based on mere transients in the data, but instead requires that the media player receive consistent orientation data over periods of time before screen changes are made. This avoids spurious changes to screen mode and makes for a user friendly automated power conservation process.

Thus, a user of an embodiment of the present invention may hold his or her media player at an orientation such that the screen is easily viewable, watching the video content of a media file and listening to the audio content. The user may then decide to cease watching the video and may simply slip the media player into his pocket in an orientation such that the top of the screen is aimed roughly downward and the video screen will automatically turn off (or dim) conserving power while the audio content continues to play normally. The user may then hear something on the audio that makes him or her want to watch the video, and take the media player out of his or her pocket. Upon lifting the media player back to a viewable orientation, the video content is returned to the screen. This allows for intelligent power consumption in a manner that enables a natural and intuitive user interaction. The user need not press buttons or make user interface selections to engage the power conservation. Instead the user simply needs to put the media player in his pocket or on his belt or otherwise store it in an orientation where the screen is roughly inverted with respect to gravity.

In some embodiments of the present invention, the headphone cable that plugs into the main casing of the media player is oriented such that it plugs into the bottom of the casing with respect to the orientation of the screen. Thus, it is a convenient location for a user to have headphones plugged in and simultaneously keep the media player in a pocket or on a belt such that the screen is upside own when the cable is pointed up. Such an orientation will trigger the software as described in the paragraphs above to turn off (or dim) the screen of the portable media player while keeping the audio content playing. In this way a user can put the media player in his pocket and/or on his belt and thereby have power conserved by reducing the power consumed by the video content of the media file. By having the audio plug on the underside (with respect to the normal viewing orientation of the screen), the media player may reside upside down in the users pocket or belt and allow for convenient routing of the headphone wires.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A portable media player with orientation-based power conservation comprising:
a casing configured to be held in a hand of a user;
a processor disposed within the casing;
a visual display affixed to the casing;
an audio display;
a main memory functionally coupled to the processor;
a secondary memory functionally coupled to the processor, the secondary memory having media content retrievably stored therein;
an orientation sensor physically coupled to the casing and functionally coupled to the processor, the orientation sensor being configured to transmit signals to the processor responsive to a spatial orientation of the casing with respect to gravity;
a program operatively loaded into the main memory having instructions executable by the processor to:
present media content by displaying visual content on the visual display and by playing audio content through the audio display; and
reduce power consumption of the visual display by lowering an intensity of a display output in response to the orientation sensor indicating that the spatial orientation of the casing is inverted with respect to gravity for more than a threshold amount of time, while continuing to play audio content through the audio display normally.

2. The portable media player according to claim 1, wherein the lowering the intensity of the display output comprises reducing a brightness of the display output.

3. The portable media player according to claim 1, wherein the lowering the intensity of the display output comprises turning off the display.

4. The portable media player according to claim 1, wherein the audio display comprises headphones or ear buds that are functionally coupled to the processor through a wired or wireless connection.

5. The portable media player according to claim 1, wherein the orientation sensor is an accelerometer.

6. The portable media player according to claim 1, wherein the indicating that the spatial orientation of the casing is inverted with respect to gravity corresponds to the visual display being oriented such that an upper edge of the display is positioned at a lower elevation with respect to gravity than a lower edge of the display.

7. The portable media player according to claim 6, wherein the indicating that the spatial orientation of the casing is inverted with respect to gravity further corresponds with the upper edge of the display being positioned at a lower elevation than the lower edge of the display by more than a threshold amount.

8. The portable media player according to claim 1, wherein the program operatively loaded into the main memory is further operative, after the power consumption of the visual display has been reduced, to resume the power consumption to a non-reduced level in response to the orientation sensor indicating that the spatial orientation of the casing has substantially returned from being inverted with respect to gravity.

9. The portable media player according to claim 8, wherein the resumption of non-reduced power consumption of the visual display is dependent upon a time threshold such that the orientation sensor indicates that the spatial orientation of the casing substantially returned from being inverted with respect to gravity for more than the time threshold amount of time.

10. The portable media player according to claim 1, wherein reducing of the power consumption to the visual display is adapted to be overridden by the user performing at least one of: manually pressing a button of the portable media player, and otherwise engaging a manual user interface element of the portable media player.

11. A method of providing orientation-based power conservation for a portable media player, the method comprising:
providing a casing configured to be held in a hand of a user;
providing a processor disposed within the casing;
providing a visual display affixed to the casing;
providing an audio display;
providing a main memory functionally coupled to the processor;
providing a secondary memory functionally coupled to the processor, the secondary memory having media content retrievably stored therein;
providing an orientation sensor physically coupled to the casing and functionally coupled to the processor, the orientation sensor being configured to transmit signals to the processor responsive to a spatial orientation of the casing with respect to gravity;
providing a program operatively loaded into the main memory having instructions executable by the processor to:
present media content by displaying visual content on the visual display and by playing audio content through the audio display; and
reduce power consumption of the visual display by lowering an intensity of a display output in response to the orientation sensor indicating that the spatial orientation of the casing is within a certain angular range for more than a threshold amount of time, while continuing to play audio content normally through the audio display.

12. The method according to claim 11, wherein the lowering the intensity of the display output comprises reducing a brightness of the display output.

13. The method according to claim 11, wherein the lowering the intensity of the display output comprises turning off the display.

14. The method according to claim 11, wherein the orientation sensor is an accelerometer.

15. The method according to claim 11, wherein the indicating that the spatial orientation of the casing is within the certain angular range corresponds to the visual display being oriented such that an upper edge of the display is positioned at a lower elevation with respect to gravity than a lower edge of the display.

16. The method according to claim 11, wherein the indicating that the spatial orientation of the casing is inverted with respect to gravity further corresponds with the upper edge of the display being positioned at a lower elevation than the lower edge of the display by more than a threshold amount.

17. The method according to claim 11, wherein the program operatively loaded into the main memory is further operative, after the power consumption of the visual display has been reduced, to resume the power consumption to a non-reduced level in response to the orientation sensor indicating that the spatial orientation of the casing has substantially returned to outside the certain angular range.

18. The method according to claim 17, wherein the resumption of non-reduced power consumption of the visual display is dependent upon a time threshold such that the orientation sensor indicates that the spatial orientation of the casing substantially returned to outside the certain angular range for more than the time threshold amount of time.

19. A method of providing orientation-based power conservation for a portable media player, the method comprising:
providing an orientation sensor physically coupled to the portable media player and functionally coupled to a processor of the portable media player, the orientation sensor being configured to transmit signals to the processor indicative of a spatial orientation of a visual display of the portable media player with respect to gravity; and
reducing power consumption of the visual display of the portable media player in response to the orientation sensor indicating a spatial orientation of the visual display that is inverted with respect to gravity for more than a threshold amount of time, while continuing to play audio content normally to a user through an audio display of the portable media player.

20. The method according to claim 19, wherein the indicating that the spatial orientation of the visual display is inverted with respect to gravity corresponds to an upper edge of the display being positioned at a lower elevation with respect to gravity than a lower edge of the display

21. The method according to claim 20, wherein the indicating that the spatial orientation of the visual display is inverted with respect to gravity further corresponds to the upper edge of the display being positioned at a lower elevation than the lower edge of the display by more than a threshold amount.

22. The method according to claim 21, wherein the media player is further operative to return the power consumption of the visual display to a non-reduced level in response to the orientation sensor indicating a spatial orientation of the visual display has returned to the spatial orientation outside the certain boundaries.

23. The method according to claim 19, wherein the reducing power consumption of the visual display comprises at least one of: dimming the visual display, and turning off the visual display.
